(19) United States
(12) Patent Application Publication
(10) Pub. No.: US 2026/0084608 A1
(43) Pub. Date: Mar. 26, 2026

(54) RECREATIONAL VEHICLE COMPRISING FOLDABLE TABLE WITH SHUTTERS

(71) Applicant: Thor Tech, Inc., Elkhart, IN (US)

(72) Inventors: Paige Mihalick, Elkhart, IN (US); Trent Tobolski, Granger, IN (US); Mitchell Johnson, Elkhart, IN (US)

(73) Assignee: Thor Tech, Inc., Elkhart, IN (US)

(21) Appl. No.: 19/331,401

(22) Filed: Sep. 17, 2025

Related U.S. Application Data
(60) Provisional application No. 63/697,035, filed on Sep. 20, 2024.

(51) Int. Cl. B60P 3/36; B60J 1/20; B60N 3/00

(52) U.S. Cl. CPC B60P 3/36; B60J 1/2094; B60N 3/001

(57) ABSTRACT

A recreational vehicle, of the type including a living space, may include an interior wall of the living space. The interior wall may comprise a window. The recreational vehicle may include a foldable table structure affixed to the interior wall. The foldable table structure may include a table surface including an opening. The table surface may be substantially against the interior wall in a stowed position and the window may be viewable or accessible through the opening in the stowed position of the foldable table structure. The table surface may be substantially perpendicular to the interior wall in an extended position of the foldable table structure.

### CROSS-REFERENCE TO RELATED APPLICATIONS

This application claims the benefit of U.S. Provisional Application Ser. No. 63/697,035, filed Sep. 20, 2024.

### BACKGROUND

The present disclosure relates to recreational vehicles (RVs). Specifically, the present disclosure relates to an RV comprising a folding table with shutters.

### BRIEF SUMMARY

According to the subject matter of the present disclosure, a foldable table structure is provided for an RV that satisfies one or more of the aforementioned desires. Particularly, a foldable table structure is provided that frees up room for movement within a living space of the RV. Further, the capability of the foldable table structure to be securely stowed against the interior wall eliminates the risk of the foldable table structure shifting or falling within the living space. As a result the foldable table structure can serve to improve safety and reduce a likelihood of damage within the living space. Additionally, the opening in the table surface of the foldable table structure may provide view or access to the window while the foldable table structure is in the stowed position. Further the shutters of the foldable table structure may be operable to fill or cover the opening while the foldable table structure is in the stowed position, which increases security and privacy of the living space, if desired.

In accordance with one embodiment of the present disclosure, a recreational vehicle, of the type comprising a living space, the recreational vehicle may comprise an interior wall of the living space. The interior wall may comprise a window. The recreational vehicle may comprise a foldable table structure affixed to the interior wall. The foldable table structure may comprise a table surface including an opening. The table surface may be substantially against the interior wall in a stowed position and the window may be viewable or accessible through the opening in the stowed position of the foldable table structure. The table surface may be substantially perpendicular to the interior wall in an extended position of the foldable table structure.

In accordance with another embodiment of the present disclosure, a foldable table structure may be mounted to a wall comprising a window. The foldable table structure may comprise a table surface including an opening. The table surface may be substantially against the wall in a stowed position and the window may be viewable or accessible through the opening in the stowed position of the foldable table structure. The table surface may be substantially perpendicular to the wall in an extended position of the foldable table structure. The foldable table structure may include one or more shutters operable to fill or cover the opening while in a closed position, and to expose the opening while in an opened position, or may include a glazing material within the opening.

Although the concepts of the present disclosure are described herein with primary reference to RVs, it is contemplated that the concepts will enjoy applicability to any vehicle. For example, and not by way of limitation, it is contemplated that the concepts of the present disclosure will enjoy applicability to cars, trucks, tractor-trailers, or any other suitable vehicle.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 is a side view of an RV with an RV body, according to one embodiment of the present disclosure;

FIG. 2 is an isometric view of a foldable table structure in a stowed position with shutters in a closed position, according to one embodiment of the present disclosure;

FIG. 3 is an isometric view of a foldable table structure in a stowed position with shutters opened position, according to one embodiment of the present disclosure;

FIG. 4 is an isometric view of a foldable table structure in an extended position with shutters in an opened position, according to one embodiment of the present disclosure;

FIG. 5 is an isometric view of a foldable table structure with table supports in an outward position and shutters in an opened position, according to one embodiment of the present disclosure;

FIG. 6 is an isometric view of a foldable table structure with table supports in an outward position and shutters in a closed position, according to one embodiment of the present disclosure;

### DETAILED DESCRIPTION

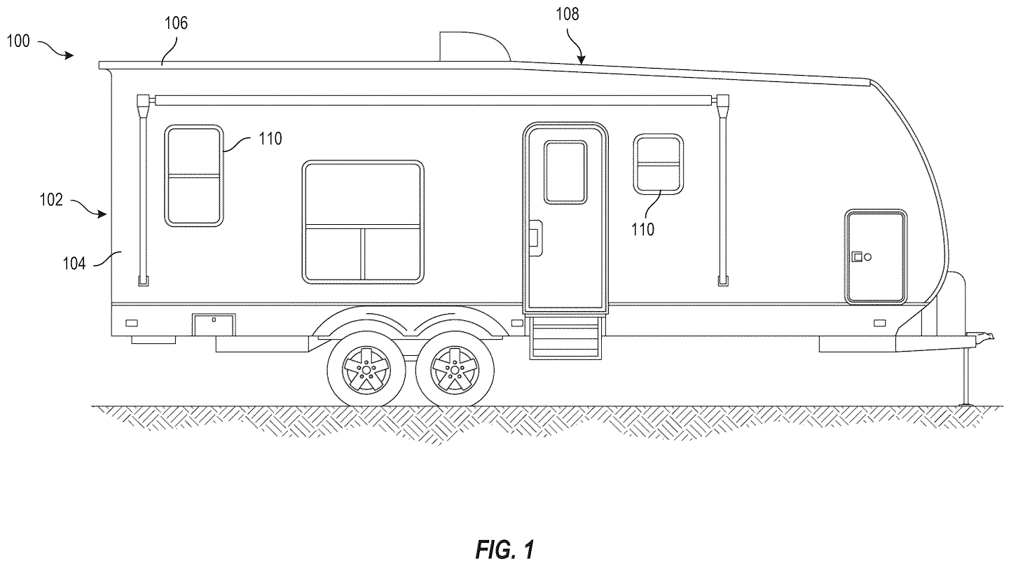

FIG. 1 depicts a recreational vehicle (RV) 100 with an RV body 102. The RV body 102 may include an RV roof 104 and RV walls 106 that define a living space 108 (e.g., a space in which passengers may reside). The RV walls 106 may include one or more windows 110 at one or more locations. Moreover, one or more elements may be located within the living space 108 of the RV 100, such as one or more beds, kitchen appliances, couches, chairs, tables, or the like. Embodiments of the present disclosure are directed to a foldable table structure positioned near a window 110 of the RV 100. In some embodiments, the foldable table structure comprises a table surface with an opening. The table surface may be substantially against an interior wall of the living space 108 such that the window 110 is viewable or accessible through the opening in a stowed position of the foldable table structure. Further, in some embodiments, the foldable table structure may comprise one or more shutters. The one or more shutters may be operable to fill or cover the opening while in a closed position (e.g., to provide a table space for passengers while the foldable table structure is in an extended position from the interior wall of the living space 108, and to expose the opening while in an opened position (e.g., such that the window 110 is viewable or accessible through the opening while the foldable table structure is in a stowed position).

The RV 100 may be, for example, a towable trailer or a motorized recreational vehicle, such as a motorhome, a fifth wheel camper, a toy hauler, a travel trailer, a teardrop camper, a tiny trailer, a pop-up camper, or any other vehicle.

Embodiments of the present disclosure directed to a foldable table structure affixed to an interior wall of the living space 108 of the RV 100. In some embodiments, the capability of the foldable table structure to be stowed (e.g., along the interior wall) frees up room for movement within the living space 108 of the RV 100 or for other uses. Further, the capability of the foldable table structure to be securely stowed against the interior wall eliminates the risk of the foldable table structure shifting or falling within the living space 108 (e.g., while the RV 100 is in motion, during a sudden stop or start of the RV 100, during a turn of the RV 100, or the like). As a result the foldable table structure described herein can serve to improve safety and reduce a likelihood of damage within the living space 108 during operation of the RV 100. Additionally, the opening in the table surface of the foldable table structure may provide view or access to the window 110 while the foldable table structure is in the stowed position. Further the shutters of the foldable table structure may be operable to fill or cover the opening while the foldable table structure is in the stowed position, which increases security and privacy of the living space 108, if desired.

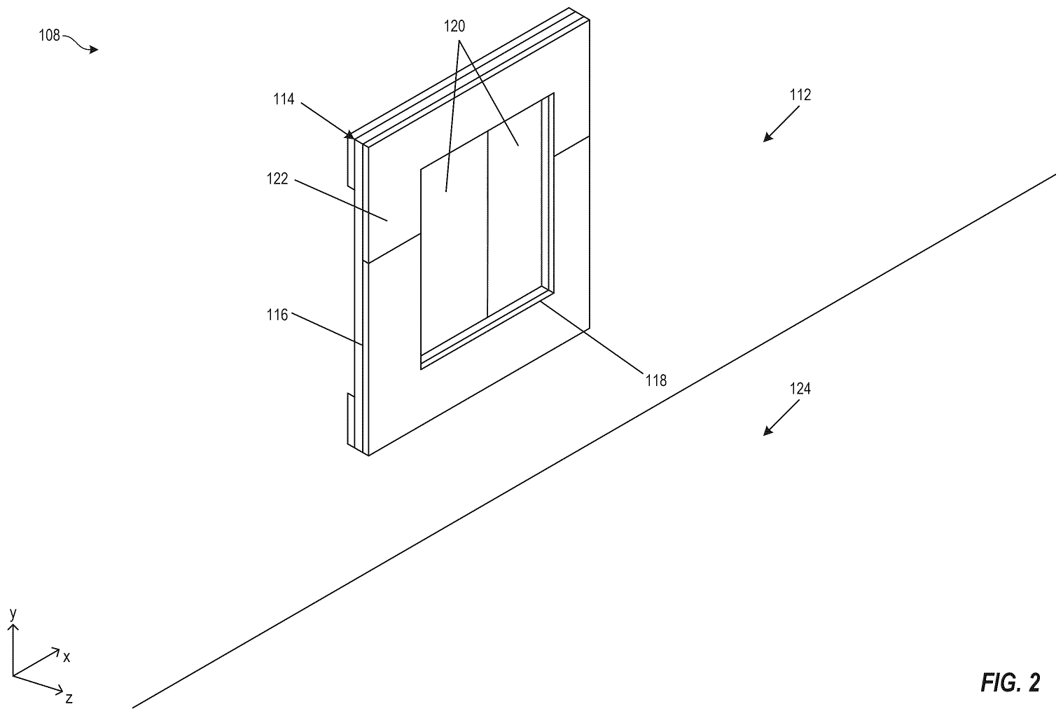

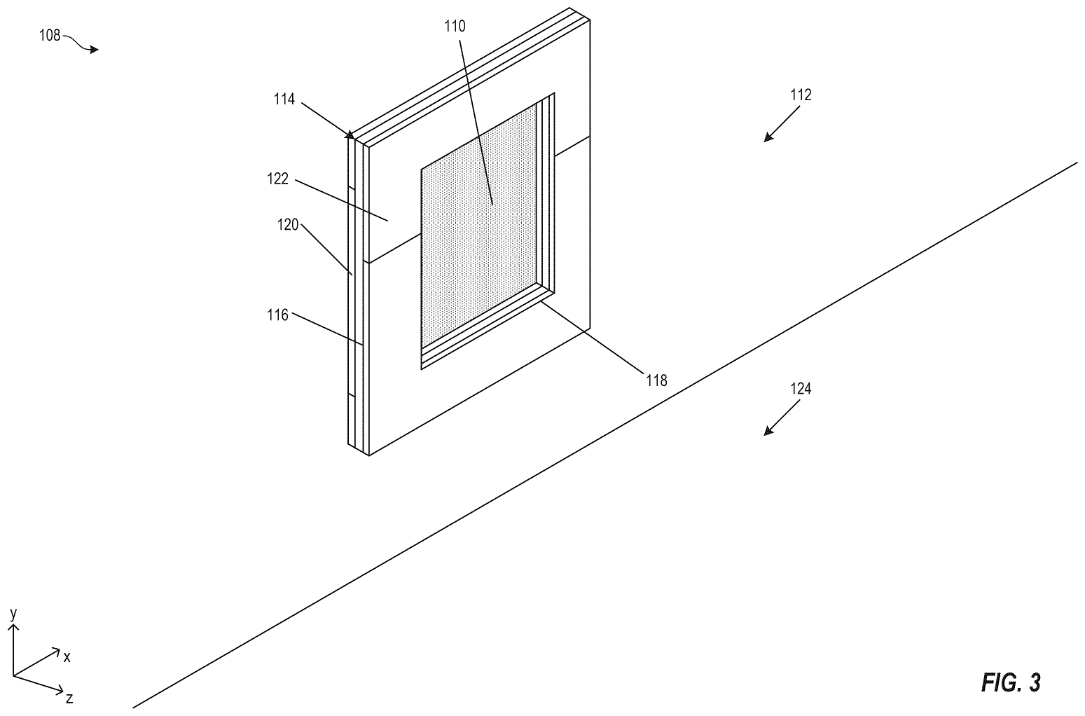

Referring now to FIG. 2, an interior wall 112 of the living space 108 is depicted. Specifically, the interior wall 112 of the living space 108 includes a window 110 (hidden behind one or more shutters 120 in FIG. 2) in the interior wall 112, and a foldable table structure 114 adjacent the window 110. In FIG. 2, the foldable table structure 114 is depicted in a stowed position. In the stowed position, the foldable table structure 114 is folded against the interior wall 112 of the living space 108. In FIG. 2, the one or more shutters 120 are in a closed position so as to block the window 110 (e.g., to increase privacy or security of the living space 108). Conversely, in FIG. 3, the one or more shutters 120 are depicted in an opened position (e.g., so as to give passengers access to the window 110 through the foldable table structure 114). In some embodiments, to reach the opened position while the foldable table structure 114 is in the stowed position as depicted in FIG. 3, the one or more shutters 120 are operable to slide (e.g., along an x-direction in FIG. 3) such that the shutters are within the foldable table structure 114 (e.g., rather than blocking the window 110).

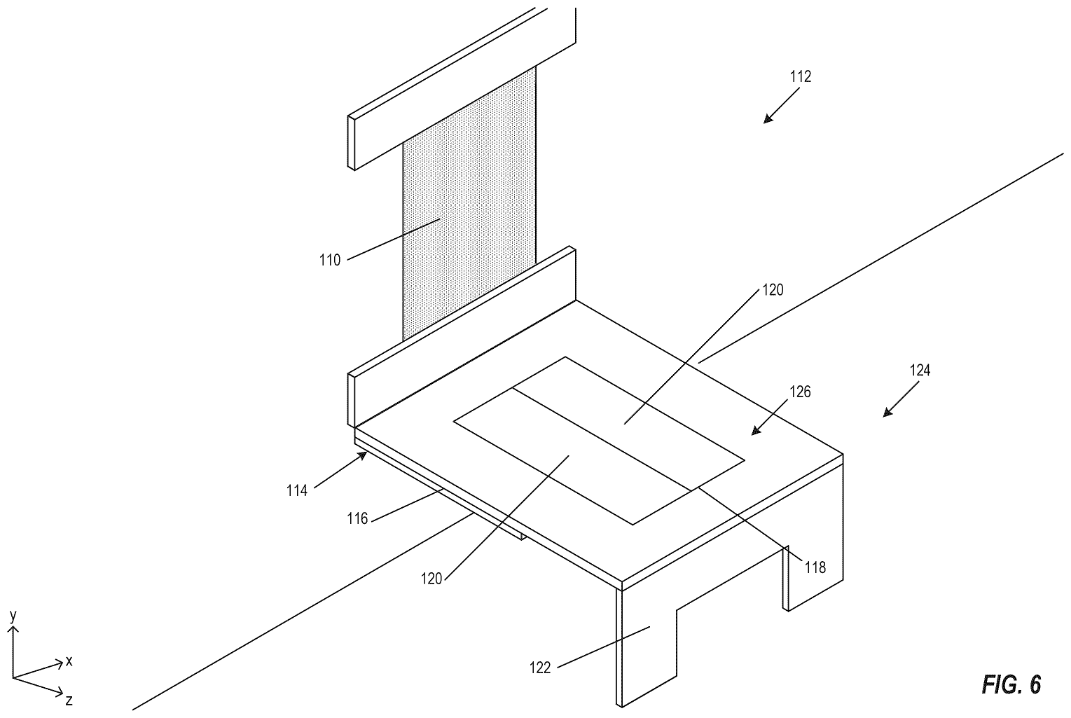

FIGS. 2-6 depict the foldable table structure 114 transitioning from the stowed position (e.g., as shown in FIG. 2) to an extended position (e.g., as shown in FIG. 6), and transitional positions therebetween. In some embodiments, while the foldable table structure 114 is in the stowed position and the one or more shutters 120 are in the opened position, the foldable table structure 114 may provide passenger access to the window 110. In some embodiments, while the foldable table structure 114 is in the extended position and the one or more shutters 120 are in the closed position, the foldable table structure 114 may provide passenger access to a table space. Components/positioning of the foldable table structure 114 are described further herein.

In some embodiments, the foldable table structure 114 includes a table surface 116. In some embodiments, the table surface 116 may be substantially against the interior wall 112 such that the window 110 is viewable or accessible through the opening 118 while the foldable table structure 114 is in the stowed position (and while the one or more shutters 120 are in the opened position). Further, in some embodiments, the table surface 116 may be substantially perpendicular to the interior wall 112 while the foldable table structure 114 is in an extended position.

In some embodiments, the table surface 116 comprises an opening 118 (e.g., an opening in a central region of the table surface 116). In some embodiments, a size (e.g., a width in the x-direction, a height in the y-direction) of the opening 118 matches or is similar to a size of the window 110. In some embodiments, the opening 118 is sized such that the opening surrounds the window 110 (e.g., while the foldable table structure 114 is in the stowed position). Thus, a size of the table surface 116 and/or a size of the opening 118 may be selected depending on a size and/or a shape of the window 110. Of note, although elements of the foldable table structure 114 (e.g., the table surface 116, the opening 118, or the like) and the window 110 are depicted as being rectangular in shape in FIGS. 2-6, the elements of the foldable table structure 114 and the window 110 may be another shape (e.g., circular, square, triangular, or the like).

In some embodiments, the one or more shutters 120 of the foldable table structure 114 are operable to fill or cover the opening 118 while in the closed position, and to expose the opening 118 (e.g., leave the opening unfilled or uncovered) while in the opened position. In some embodiments, the one or more shutters 120 being in the opened position allows for the foldable table structure 114 to be in the stowed position (e.g., folded against the interior wall 112) while still providing view or access to the window 110. As noted above, the one or more shutters 120 are depicted in an opened position in FIG. 3. Alternatively, the one or more shutters 120 may be in the closed position while the foldable table structure 114 in the stowed position, which serves to block view or access to the window 110, thereby increasing privacy and security of the living space 108. Further, the one or more shutters 120 being in the closed position may conserve energy usage of the RV 100, as the one or more shutters 120 may insulate the living space 108 and block sunlight from entering the living space 108, which can reduce a loads on an air-conditioning/heater of the RV 100. As noted above, the one or more shutters 120 are depicted in the closed position in FIG. 2.

In some embodiments, the one or more shutters 120 are affixed to the table surface 116 using a hinged connection. That is, in some embodiments, the one or more shutters 120 may be hinged to the table surface 116 of the foldable table structure 114 (e.g., such that the one or more shutters 120 are operable to swing inward (e.g., to cover or fill the opening 118 in the closed position) or outward (e.g., to expose the window 110 in the opened position). Specifically, in some embodiments, the one or more shutters 120 may be hinged to vertical portions of the table surface 116 of the foldable table structure 114. Alternatively, in some embodiments, the one or more shutters 120 may be hinged to horizontal portions of the table surface 116 of the foldable table structure 114. In some embodiments, while the one or more shutters 120 are in the opened position, the one or more shutters 120 may be sized so as to rest flushy on the table surface 116 of the foldable table structure 114.

Alternatively, the one or more shutters 120 may be affixed to the table surface 116 using a slidable connection. That is, in some embodiments, the one or more shutters 120 may be slidably connected to the table surface 116 the foldable table structure 114, such that the one or more shutters 120 may slide behind the table surface 116 of the foldable table structure 114 (e.g., to provide view or access to the window 110), or may slide out from behind the table surface 116 of the foldable table structure 114 so as to cover or fill the opening 118 (e.g., to block view or access to the window 110). In some embodiments, the foldable table structure 114 may comprise a locking mechanism (e.g., a magnetic lock, a latch, or the like) that serves to lock the one or more shutters 120 in the opened position or in the closed position. In some embodiments, the one or more shutters 120 may transition from the opened position to the closed position (and vice versa) manually (e.g., by hand) or through a motorized mechanism (e.g., through the use of a remote control that powers a motor coupled to the one or more shutters 120).

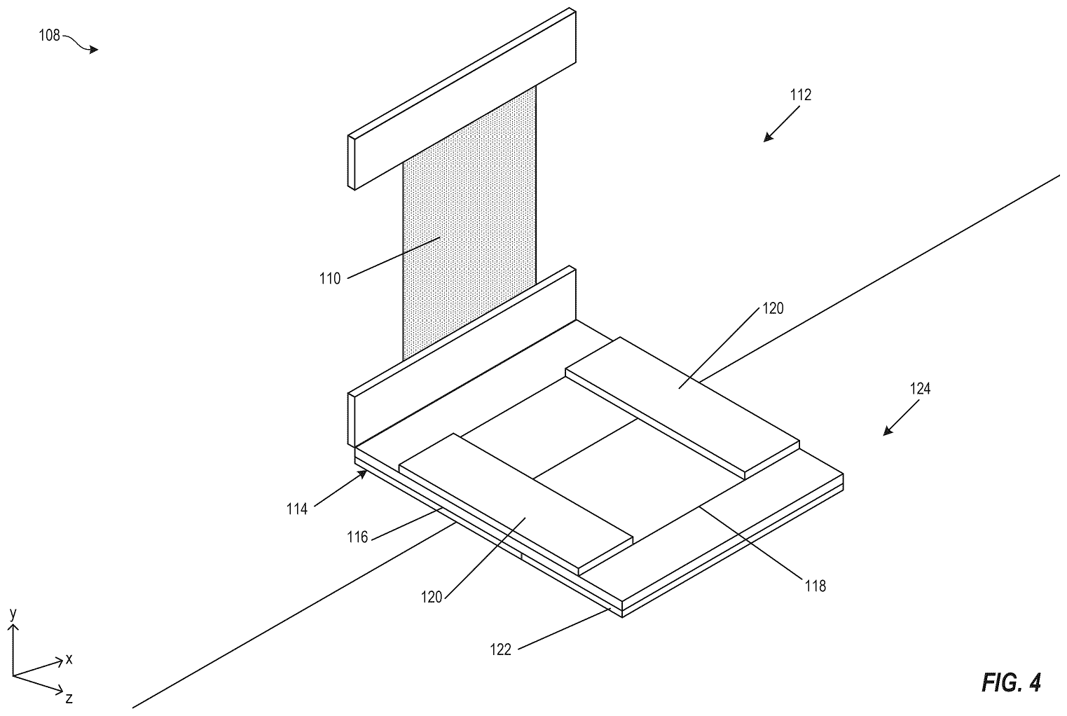

In some embodiments, the foldable table structure 114 may be affixed to the interior wall 112 using a hinged connection. For example, in some embodiments, one or more hinges may be coupled to a bottom end of the foldable table structure 114 such that the foldable table structure 114 may extend outward from the interior wall 112 of the living space 108 and into the extended position (e.g., as depicted in FIG. 4). In some embodiments, the foldable table structure 114 may include one or more slidable extensions that serve to increase a size (e.g., a length in the z-direction while the foldable table structure 114 is in the extended position).

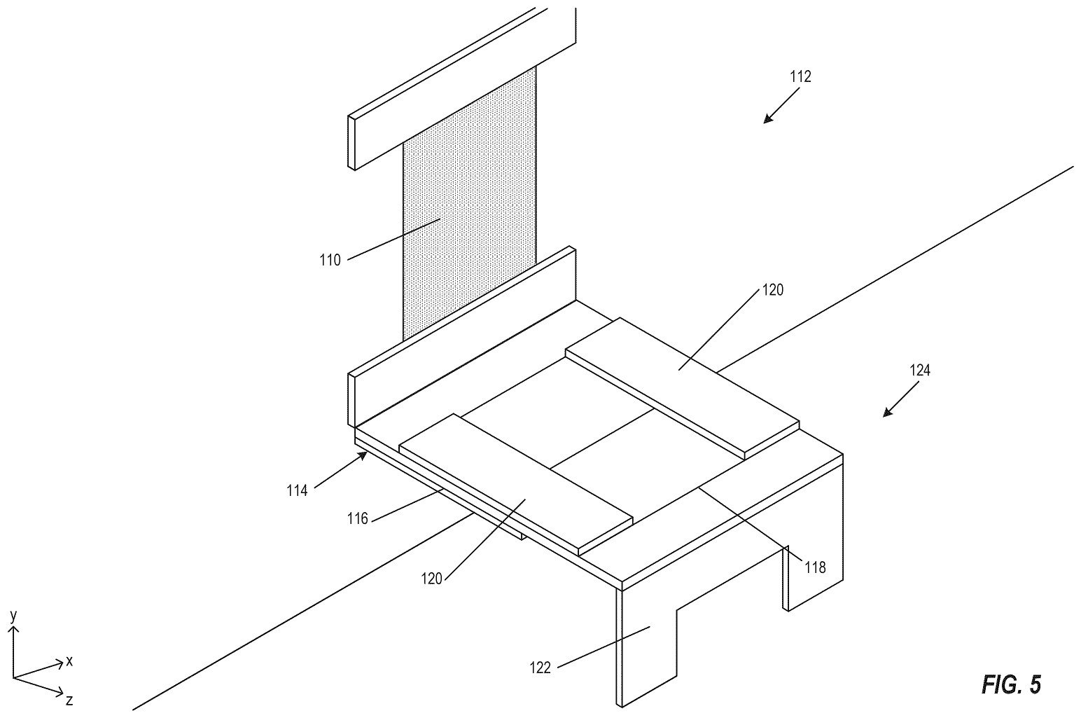

In some embodiments, the foldable table structure 114 may further include one or more table supports 122. In some embodiments, the one or more table supports 122 may be folded against the table surface 116 while the foldable table structure 114 is in the stowed position (e.g., as depicted in FIGS. 2 and 3). That is, the table supports 122 may in some embodiments be in an inward position when the foldable table structure 114 is in the stowed position. Further, the one or more table supports 122 may be substantially perpendicular to the table surface 116 to support the table surface 116 while the foldable table structure 114 is in the extended position (e.g., as depicted in FIGS. 5 and 6). That is, while the foldable table structure 114 is in the extended position, the table supports 122 may be operable to fold outward to an outward position in which the one or more table supports 122 are substantially perpendicular to the table surface 116. In some embodiments, the one or more table supports 122 may be hinged to the table surface 116 of the foldable table structure 114. In some embodiments, the table supports 122 may serve to support the foldable table structure 114 while the foldable table structure 114 is in the extended position. Thus, in some embodiments, the table supports 122 may be of a size that matches or is similar to a distance from a hinged connection of the foldable table structure to the interior wall 112 to an interior floor 124. In some embodiments, the foldable table structure 114 may comprise one or more table supports 122.

Referring now to FIG. 6, as noted above, the one or more shutters 120 may be in the closed position while the foldable table structure 114 is in the extended position. In some embodiments, the table surface 116 may comprise a lip along one or more edges of the opening 118. The lip may serve to support the one or more shutters 120 while the one or more shutters 120 are in the closed position (e.g., to prevent the one or more shutters 120 from falling through the opening 118 and/or to reduce stress on a connection between the one or more shutters 120 and the table surface 116). As depicted in FIG. 6, the table surface 116 and the one or more shutters 120 may combine to form a composite surface 126. The composite surface 126 may function as, for example, a workspace, an eating area, or may be used for another purpose. Of note, the composite surface 126 is advantageously positioned adjacent to the window 110 such that passengers within the living space 108 may utilize the composite surface 126 while having view or access to the window 110.

In some embodiments, one or more elements of the foldable table structure 114 (e.g., the table surface 116, the one or more shutters 120, the one or more table supports 122, or the like) may comprise a wood material, a metal material, a plastic material, or another suitable material. In some embodiments, the one or more shutters 120 may comprise a transparent material (e.g., such that the window 110 is still visible even when the one or more shutters 120 are in the closed position).

In some embodiments, in addition to or in alternative to the one or more shutters 120, the foldable table structure 114 may comprise a glazing material (e.g., plastic, glass, or the like) within the opening 118. That is, rather than or in addition to the one or more shutters 120, the opening may be covered or filled with a glazing material. In some embodiments, the glazing material may be transparent. In some embodiments, the glazing material may be an electrochromic material. In such embodiments, the electrochromic glazing material may be tinted through application of electrical stimulus. In this way, the electrochromic glazing material may serve to block the window 110 as desired (e.g., to improve privacy and/or security of the living space 108). In some embodiments, the tint of the electrochromic glazing material may be controlled through the use of a remote control that selective applies electrical stimulus to the electrochromic glazing material as desired by a passenger.

Embodiments of the present disclosure further encompass methods of installing, stowing, and extending the foldable table structure 114 described herein, such as affixing the foldable table structure 114 to the interior wall 112 of the living space 108 and transitioning the foldable table structure 114 from the stowed position to the extended position (and vice versa).

Collectively, the various features of the foldable table structure described herein provide practical advantages with respect to space efficiency and safety. For example, the living space 108 of the RV 100 is limited, and the capability of the foldable table structure 114 to be stowed in a compact fashion frees up additional room for movement within the living space 108 or for other uses. Further, the capability of the foldable table structure 114 to be securely stowed eliminates the risk of the foldable table structure 114 shifting or falling within the living space 108 (e.g., while the RV 100 is in motion, during a sudden stop or start of the RV 100, during a turn of the RV 100, or the like), thereby improving safety and reducing a likelihood of damage within the living space 108 during operation of the RV 100. Additionally, the opening 118 in the table surface 116 of the foldable table structure 114 may provide view or access to the window 110 while the foldable table structure 114 is in the stowed position. Further the one or more shutters 120 of the foldable table structure 114 may be operable to fill or cover the opening 118 while the foldable table structure 114 is in the stowed position, thereby increasing security and privacy of the living space 108, if desired.

Although characteristics of the foldable table structure 114 have been described in the environment of a living space 108 of an RV 100, it should be understood that the characteristics the foldable table structure 114 may be applied to a foldable table structure used in an environment other than a living space of an RV, such as a foldable table structure mounted on or within a vehicle of another type (e.g., a maritime vehicle, an aerial vehicle, or the like), or even in non-vehicular environment (e.g., a home).

For the purposes of describing and defining the present invention it is noted that the terms like “substantially,” “approximately,” and “about” are utilized herein to represent the inherent degree of uncertainty that may be attributed to any quantitative comparison, value, measurement, or other representation. The terms “substantially,” “approximately,” and “about” are also utilized herein to represent the degree by which a quantitative representation may vary from a stated reference without resulting in a change in the basic function of the subject matter at issue.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components described above may be combined or added together in any permutation to define embodiments disclosed herein. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. A recreational vehicle of the type comprising a living space, the recreational vehicle comprising:
an interior wall of the living space, wherein the interior wall comprises a window; and
a foldable table structure affixed to the interior wall, wherein the foldable table structure comprises:
a table surface including an opening,
wherein the table surface is substantially against the interior wall in a stowed position and the window is viewable or accessible through the opening in the stowed position of the foldable table structure, and
wherein the table surface is substantially perpendicular to the interior wall in an extended position of the foldable table structure.

2. The recreational vehicle of claim 1, wherein the foldable table structure further comprises one or more shutters operable to fill or cover the opening while in a closed position.

3. The recreational vehicle of claim 2, wherein the one or more shutters are operable to expose the opening while in an opened position.

4. The recreational vehicle of claim 2, wherein the one or more shutters are affixed to the table surface using a hinged connection or a slidable connection.

5. The recreational vehicle of claim 1, further comprising a glazing material within the opening.

6. The recreational vehicle of claim 5, wherein the glazing material comprises an electrochromic material.

7. The recreational vehicle of claim 1, wherein the table surface comprises a lip along one or more edges of the opening, wherein the one or more shutters are supported by the lip in the closed position.

8. The recreational vehicle of claim 1, wherein the foldable table structure is affixed to the interior wall using a hinged connection.

9. The recreational vehicle of claim 1, wherein the foldable table structure further comprises one or more table supports, wherein:
the one or more table supports are folded against the table surface in the stowed position of the foldable table structure, and
the one or more table supports are substantially perpendicular to the table surface to support the table surface in the extended position of the foldable table structure.

10. The recreational vehicle of claim 1, wherein a size of the opening matches or is similar to a size of the window.

11. The recreational vehicle of claim 1, wherein the opening is sized such that the opening surrounds the window.

12. The recreational vehicle of claim 1, wherein the foldable table structure is affixed to the interior wall using a first hinged connection and the foldable table structure further comprises one or more table supports, wherein the one or more table supports are affixed to a table surface of the foldable table structure using a second hinged connection.

13. A foldable table structure mounted to a wall comprising a window, the foldable table structure comprising:
a table surface including an opening,
wherein the table surface is substantially against the wall in a stowed position and the window is viewable or accessible through the opening in the stowed position of the foldable table structure, and
wherein the table surface is substantially perpendicular to the wall in an extended position of the foldable table structure; and
at least one of:
one or more shutters operable to fill or cover the opening while in a closed position, and to expose the opening while in an opened position, or
a glazing material within the opening.

14. The foldable table structure of claim 13, wherein the glazing material comprises an electrochromic material.

15. The foldable table structure of claim 13, wherein the one or more shutters are affixed to the table surface using a hinged connection or a slidable connection.

16. The foldable table structure of claim 13, wherein the table surface comprises a lip along one or more edges of the opening, wherein the one or more shutters are supported by the lip in the closed position.

17. The foldable table structure of claim 13, wherein the foldable table structure is affixed to the wall using a hinged connection.

18. The foldable table structure of claim 13, wherein the foldable table structure further comprises one or more table supports, wherein:
the one or more table supports are folded against the table surface in the stowed position of the foldable table structure, and
the one or more table supports are substantially perpendicular to the table surface to support the table surface in the extended position of the foldable table structure.

19. The recreational vehicle of claim 13, wherein a size of the opening matches or is similar to a size of the window.

20. The recreational vehicle of claim 13, wherein the opening is sized such that the opening surrounds the window.
